(19) United States
(12) Patent Application Publication
(10) Pub. No.: US 2026/0007100 A1
(43) Pub. Date: Jan. 8, 2026

(54) SYSTEMS AND METHODS FOR TRANSFERRING AGRICULTURAL MATERIAL

(71) Applicant: DEERE & COMPANY, Moline, IL (US)

(72) Inventors: Ryan C. Russell, Orion, IL (US); Corey A. Akers, Highlands Ranch, CO (US); Duane M. Bomleny, Geneseo, IL (US); Jeremy D. Flahaven, Moline, IL (US); Teresa M. Spencer, East Moline, IL (US); Bradley K. Yanke, Eldridge, IA (US)

(21) Appl. No.: 18/765,974

(22) Filed: Jul. 8, 2024

(51) Int. Cl. A01D 43/07; A01D 61/00

(52) U.S. Cl. CPC A01D 43/07; A01D 61/004; A01D 61/008

(57) ABSTRACT

A receiving vehicle can include a transfer assembly for transferring agricultural material from a transferring vehicle to the receiving vehicle as the transferring vehicle is performing a harvesting operation, and while the receiving and transferring vehicles travel along a field. The transfer assembly can be selectively displaceable between a retracted, or compacted, state and an extended state. At the extended state, a transfer body of the transfer assembly can be positioned to receive agricultural material released from the transferring vehicle. The agricultural material can be released from the transferring vehicle in a variety of manners, including via reliance on gravitational forces. The transfer assembly can include one or more conveyors that are driven using power from the receiving vehicle to convey the received agricultural material along the transfer body and to a location at which the agricultural material can be dispensed into a storage area of the receiving vehicle.

### FIELD OF THE DISCLOSURE

The present disclosure generally relates to agricultural vehicles, and, more specifically, to unloading an agricultural material from a transferring vehicle to a receiving vehicle using a transfer assembly of the receiving vehicle.

### BACKGROUND

Agricultural machines, including vehicles and equipment, can be used to perform different agricultural tasks. For example, one or more agricultural machines, including, but not limited to harvesters and windrowers, can be utilized to plant crops, harvest crops, bale or otherwise collect crops, and spray or distribute crop inputs, such as, for example, fertilizer or chemicals, over a field or plants within a field.

### SUMMARY

The present disclosure may include one or more of the following features and combinations thereof.

In one embodiment of the present disclosure, a receiving vehicle is provided for hauling an agricultural material transferred to the receiving vehicle from a transferring vehicle as the transferring vehicle is harvesting the agricultural material. The receiving vehicle can include a plurality of ground engagement bodies, at least one power source, and a storage area configured to store the agricultural material. The transfer assembly can include a transfer body, a transfer actuator, and a conveyor. The conveyor can be housed within at least a portion of the transfer body, and can be driven by an operation of the transfer actuator, the transfer actuator being powered by the at least one power source. Additionally, the transfer body can include a first end and a second end. The second end can be configured to receive agricultural material as the agricultural material is released from the transferring vehicle. The conveyor can be configured to transfer the agricultural material received at the second end to the first end, the first end being positioned for a release of the agricultural material into the storage area.

According to another embodiment, a receiving vehicle is provided for hauling an agricultural material transferred to the receiving vehicle. The receiving vehicle can include a ground engagement body, a power source, a storage area configured to store the agricultural material, and a transfer assembly. The transfer assembly can include a transfer body, a transfer actuator, and a conveyor. At least a portion of the transfer assembly can be selectively displaceable between a retracted state and an extended state via an operation of an extension actuator, the extension actuator being powered by the power source. The conveyor can be housed within at least a portion of the transfer body and driven by an operation of the transfer actuator to displace agricultural material from a second end to a first end of the transfer body. Further, the transfer actuator can be powered by the power source. The second end of the transfer body can be displaceable from a first position to a second position with a displacement of the portion of the transfer assembly from the retracted state to the extended state, the second position being further from the storage area than the first position. Additionally, the first end of the transfer body can be positioned, with the transfer assembly at the extended state, for a release of the agricultural material from the transfer assembly into the storage area.

Additionally, according to an other embodiment, a method is provided for transferring an agricultural material from a transferring vehicle to a receiving vehicle using a transfer assembly of the receiving vehicle. The method can include generating, by one or more processors, a signal to facilitate an operation of an extension actuator of the receiving vehicle to displace at least a portion of the transfer assembly from a retracted state to an extended state. Further, a second end of a transfer body of the transfer assembly can be displaced, by displacement of the portion of the transfer assembly to the extended state, to a position to receive the agricultural material from the transferring vehicle. The one or more processors can also generate, as the receiving vehicle and the transferring vehicle travel along a field as the transferring vehicle is performing a harvesting operation and the portion of the transfer assembly is in the extended state, a signal to facilitate a displacement of a gate of the transferring vehicle from a close position to an open position. The open position of the gate can be configured to accommodate a release of the agricultural material from the transferring vehicle to the second end of the transfer body. The method can also include generating, by the one or more processors, a signal to activate a transfer actuator to operate a conveyor of the transfer assembly to displace the agricultural material being received from the transferring vehicle at the second end of the transfer body to a first end of the transfer body. Further, the first end of the transfer body can be positioned to accommodate a release of the agricultural material from the transfer assembly and into a storage area of the receiving vehicle.

These and other features of the present disclosure will become more apparent from the following description of the illustrative embodiments.

### BRIEF DESCRIPTION OF THE DRAWINGS

The disclosure contained herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an exemplary embodiment of an agricultural machine in the form of a transferring vehicle.

FIG. 2 illustrates an exemplary transfer management system having a receiving vehicle configured to transfer agricultural material from a transferring vehicle to the receiving vehicle.

FIGS. 3A and 3B illustrate another exemplary embodiment of a transfer management system in which a transfer assembly of the receiving vehicle is in a retracted state and an extended state, respectively.

FIGS. 4A and 4B illustrate an exemplary embodiment of a portion of a transfer management system in which a transfer assembly of a receiving vehicle is in the retracted state and the extended state, respectively.

FIGS. 5, and 6 illustrate additional exemplary embodiments of a portion of a transfer assembly of a receiving vehicle.

FIG. 7 illustrates a block diagram of an exemplary transfer management system configured for using a transfer assembly of a receiving vehicle to transfer an agricultural material from a transferring vehicle to the receiving vehicle.

FIG. 8 illustrates a simplified flow diagram of an exemplary method of using a transfer management system for transferring agricultural material from a transferring vehicle to a receiving vehicle.

Corresponding reference numerals are used to indicate corresponding parts throughout the several views.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such feature is required in all embodiments and, in some embodiments, may not be included or may be combined with other features.

Embodiments of the subject disclosure provide a systems and methods for unloading an agricultural material, such as, for example a harvested crop including, but not limited to, corn or grain, among others, from a transferring vehicle to a receiving vehicle. According to such embodiments, the receiving vehicle includes a transfer assembly that is configured to convey the harvested crop from the transferring vehicle (e.g., harvester) to the receiving vehicle (e.g., grain cart). Such embodiments can minimize, if not eliminate, power consumed from one or more power sources, including, but not limited to, electrical power (e.g., power stored by one or more batteries), mechanical power, including but not limited to, power associated with the driving or operation of belts, gears, chains, or other transmission related components, hydraulic power, or pneumatic power, among other types of power, of the transferring vehicle (e.g., harvester) in association with the transfer of the agricultural material to the receiving vehicle, thereby conserving use of the electrical power for other operations of the transferring vehicle. Moreover, as the transfer assembly is controlled and operated by the receiving vehicle, operation of the transfer assembly can instead utilize power from one or more power sources (e.g., electrical power stored by one or more battery(ies), among other types of mechanical, hydraulic, or pneumatic power sources, among others) of the receiving vehicle. Additionally, the receiving vehicle can be configured such that, as least during the transfer of the agricultural material to the receiving vehicle, the receiving vehicle can follow in the same tram lines being, have been, or will be used by the transferring vehicle, thereby minimizing areas in the field that can be subjected to soil compaction relating to the travel of at least the transferring and receiving vehicles. Further, as the conveyance of the agricultural material to the receiving vehicle can occur as the transferring vehicle is harvesting the agricultural material, embodiments of the subject disclosure can accommodate at least a reduction in the operating weight of the transferring vehicle, which can be beneficial with at least respect to soil compaction. Further, such a transfer during operation of the transferring vehicle can also allow the transferring vehicle to have smaller storage tanks (e.g., grain tank), if not eliminate the inclusion of such storage tanks, thereby providing savings in terms of the construction, weight, and operation of the transferring vehicle.

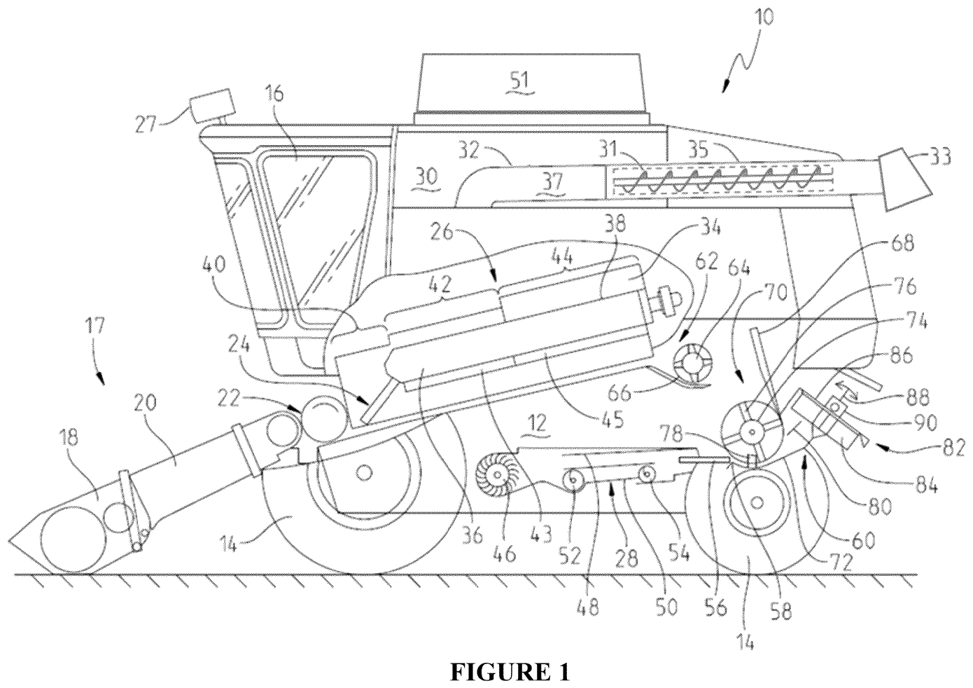

FIG. 1 illustrates an exemplary embodiment of an agricultural machine in the form of a transferring vehicle 10 that is a harvester. The illustrated transferring vehicle 10 includes a frame 12 and one or more ground engaging bodies 14, such as, for example, wheels or tracks, which are in contact with an underlying ground surface. In the illustrative embodiment, the ground engaging bodies 14 are coupled to the frame 12 and are used for propulsion of the transferring vehicle 10 in a forward operating direction (which is to the left in FIG. 1) and in other directions. In some embodiments, operation of the transferring vehicle 10 is controlled from an operator cab 16. The operator cab 16 can include any number of controls for controlling the operation of the transferring vehicle 10, such as a user interface. In some embodiments, operation of the transferring vehicle 10 can be conducted by a human operator in the operator cab 16, a remote human operator, or an automated system. Thus, according to certain embodiments, the transferring vehicle 10 can be an autonomous or semi-autonomous vehicle. Moreover, according to certain embodiments, the transferring vehicle 10 can be, or be operated, as an unmanned vehicle. Thus, according to certain embodiments, the transferring vehicle 10 may not include an operator cab 16.

The transferring vehicle 10 can also include an agricultural system. For example, as mentioned above, the illustrated transferring vehicle 10 is a harvester. Thus, the agricultural system can include a plurality of components, or subsystems, relating to the transferring vehicle 10 performing an agricultural operation at least in the form of harvesting crops. Thus, the agricultural systems for different types of transferring vehicles 10 can be configured, including having components or subsystems, for the particular agricultural operation(s) that is to be performed by that transferring vehicle 10. For example, the agricultural system of a transferring vehicle 10 in the form of a windrower can be configured to perform agricultural operations at least relating to the formation of windrows.

With respect to the exemplary transferring vehicle 10 depicted in FIG. 1, the transferring vehicle 10 can include a header system 17 having a header or harvesting head 18 is disposed at a forward end of the transferring vehicle 10 and is used to harvest crop and to conduct the harvested crop to a slope conveyor 20 of the header system 17. A variety of different heads 18 can be utilized, including, for example, a forage harvesting header, draper header, or corn header, among others.

The slope conveyor 20 conducts the harvested crop to a guide drum 22. The guide drum 22 of the transferring vehicle 10 guides the harvested crop to an inlet 24 of a threshing assembly 26, as shown in FIG. 1. The threshing assembly 26 of the transferring vehicle 10 includes a housing 34 and one or more threshing rotors. A single threshing rotor 36 is shown in FIG. 1, and the threshing rotor 36 includes a drum 38. The threshing assembly 26 includes a charging section 40, a threshing section 42, and a separating section 44. The charging section 40 is arranged at a front end of the threshing assembly 26, the separating section 44 is arranged at a rear end of the threshing assembly 26, and the threshing section 42 is arranged between the charging section 40 and the separating section 44.

Harvest crop that includes grain, such as corn, and material other than grain (MOG) falls through a thresher basket 43 positioned in the threshing section 42 and through a separating grate 45 positioned in the separating section 44. The harvested crop can be directed to a clean crop routing assembly 28 with a blower 46 and sieves 48, 50 with louvers. The sieves 48, 50 can be oscillated in a fore-and-aft direction. The clean crop routing assembly 28 of the transferring vehicle 10 removes the MOG and guides grain over an unloading conveyor 52 to an elevator for grain. The elevator for grain deposits the grain in a grain tank 30 of the transferring vehicle 10, as shown in FIG. 1. The grain in the grain tank 30 can be unloaded by means of an unloading conveyor 32 to a grain wagon, trailer, or truck, for example. An auger 31, among other conveyance means, including a conveyor, within the unloading conveyor 32 can be selectively operated, such as, for example rotated, to convey the grain along the unloading conveyor 32, wherein the grain can exit the unloading conveyor 32 through a spout 33.

According to certain embodiments, a spout control system having an actuator, including, for example, a servomotor, electric motor, or an electro-hydraulic mechanism, can be utilized to adjust the state of the spout 33, including the position, orientation, or configuration of the spout 33. The spout 33 can have one or more states, such as, for example, first and second states, which can each be associated with one or more operational modes, respectively, of the transferring vehicle 10, including, for example, a transport mode and a field mode. Further, one or more sensors can be utilized to detect, or provide information to derive, the state of the of the spout 33. Such different states of the spout 33 correspond to differences in the size, shape, and location of the outer profile of at least a corresponding portion of the transferring vehicle 10.

According to certain embodiments, at least a first section 35 of the unloading conveyor 32 can be angularly displaced via selective operation of an actuator relative to another, second section 37 of the unloading conveyor 32. Further, each of the first and second sections 35, 37 of the unloading conveyor 32 can include different portions of the auger 31. Such relative displacement of the first and second sections 35, 37 of the unloading conveyor 32 can be utilized to selectively displace the unloading conveyor 32 between a folded state and an unfolded state. The folded state can be associated, for example, with operation of the transferring vehicle 10 in at least the first operational mode, such as, for example, the transport mode, and the unfolded state can be associated with another, or second operational mode, such as, for example, the field mode. Whether the unloading conveyor 32 is in the first or second state, among other states, can be determined by, or using, information provided by one or more sensors. Further, the profile of at least a portion of the transferring vehicle 10 can be different for each of the folded and unfolded states of the conveyor 32.

Harvested crop remaining at an end of the sieve 50 can, according to certain embodiments or operations, be again transported to the threshing assembly 26 by a conveyor 54 where it is reprocessed by the threshing assembly 26. Alternatively, according to other embodiments, crop remaining at the end of the sieve 50 can be transported to a rethreshing device. Harvested crop delivered at an end of the sieve 48 is conveyed by an oscillating sheet conveyor 56 to a lower inlet 58 of a crop debris routing assembly 60. Harvested crop at the threshing assembly 26 is processed by the separating section 44 resulting in straw being separated from other material of the harvested crop. The straw is ejected through an outlet 62 of the threshing assembly 26 and conducted to an ejection drum 64. The ejection drum 64 interacts with a sheet 66 arranged underneath the ejection drum 64 to move the straw rearwardly. A wall 68 is located to the rear of the ejection drum 64 and guides the straw into an upper inlet 70 of the crop debris routing assembly 60.

The crop debris routing assembly 60 of the transferring vehicle 10 includes a chopper assembly having a chopper housing 72 and a chopper rotor 74 arranged in the chopper housing 72 that rotates, for example, in a counterclockwise direction about an axis that extends, for example, perpendicular to the forward operating direction. The chopper rotor 74 includes a plurality of chopper knives 76 that are distributed around a circumference of the chopper rotor 74. The chopper knives 76 interact with opposing knives 78, which are, for example, coupled to the chopper housing 72. The chopper knives 76 and the opposing knives 78 cooperate to chop the straw into smaller pieces.

Additionally, the grain tank 30 can include one or more grain tank covers 51 that can be displaced between a first, closed state and a second, open state. In at least certain situations while the transferring vehicle 10 is operating, for example, in the field mode, the grain tank cover(s) 51 can be retained in an open state, as shown in FIG. 1. Such an open state can accommodate an unobstructed top view of the harvested and stored grain in the grain tank 30. Additionally, or alternatively, retaining the grain tank cover 51 in an open position while operating the transferring vehicle 10 in the field mode can potentially increase the capacity of the grain tank 30 by virtue of allowing a central portion of the pile of grain to extend somewhat above the top of the underlying grain tank 30. However, when operating in at least the transport mode, the grain cover(s) 51 can be retained in the closed position. One or more actuators, including, for example, motors or cylinders, as well as combinations thereof, among other actuators, can be utilized to control displacement of the grain cover 51 between the open and closed states. Whether the grain tank cover 51 is, or is not, currently in the open or closed state, as well as positions therebetween, can be determined, including identified, via information provided by one or more sensors.

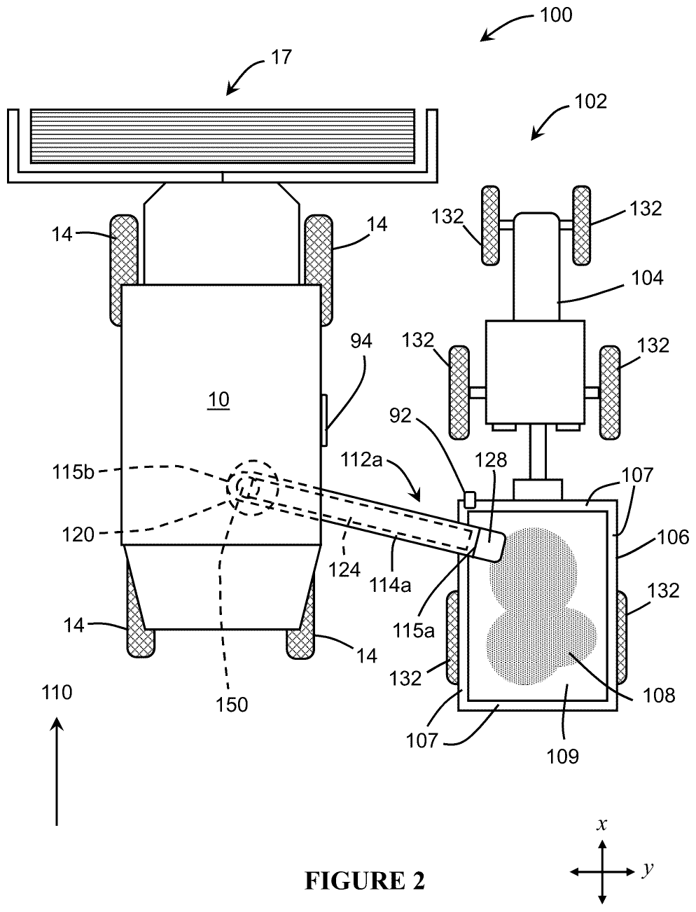

FIG. 2 illustrates an exemplary transfer management system 100 having a receiving vehicle 102 configured to transfer agricultural material 108, including, for example, harvested crop, from the transferring vehicle 10 to the receiving vehicle 102. For at least explanatory purposes, the illustrated transferring vehicle 10 is, as discussed above with respect to FIG. 1, shown as a combine having a header 17, and the receiving vehicle 102 includes a combination of at least a prime mover or propulsion unit and a storage unit. Moreover, in the illustrated embodiment, the receiving vehicle 102 includes an agricultural vehicle 104, such as, for example, a tractor, and a storage unit, such as, for example, a hauler, haulage unit, grain cart, or wagon 106, among other types of storage units (herein collectively generally referred to as “hauler 106”). The hauler 106 can include a plurality of walls 107 arranged to generally define a storage area 109 of the hauler 106 that is configured to store agricultural material 108 that is transferred to the hauler 106 from the transferring vehicle 10. According to such embodiment, the agricultural vehicle 104 can include, or provide, the prime mover or propulsion unit that is used to provide power to tow, push, pull, or otherwise move the hauler 106 along a field. However, according other embodiments, the receiving vehicle 102 can include a self-propelled hauler 106, and the hauler 106 may, or may not, be an autonomous or self-driven vehicle.

During operation of the transfer management system 100, the transferring vehicle 10 and the receiving vehicle 102 can generally move in a similar direction of travel 110. Additionally, either or both of the transferring vehicle 10 and the receiving vehicle 102 can be operated to maintain a degree of alignment between the transferring vehicle 10 and the receiving vehicle 102 in a manner that can assist in the transfer of agricultural material 108 to the receiving vehicle 102. Further, such alignment can, for example, be attained by the travel of the receiving vehicle 102 being coordinated with the travel of the transferring vehicle 10, or vice versa, or the travel of each of the vehicles 10, 102 can be coordinated with each other. However, other manners of attaining alignment between the transferring vehicle 10 and the receiving vehicle 102 can be utilized, including, but not limited to, guidance of the receiving vehicle 102 using information obtained by an optical recognition system that provides information regarding the movement or relative location of the transferring vehicle 10. Additionally, such coordinated or aligned travel of the transferring vehicle 10 and the receiving vehicle 102 can be predetermined, and the heading and speed of each of the vehicles 10, 102, can, at least periodically, be separately adjusted to retain a particular relative position(s) of the vehicles 10, 102.

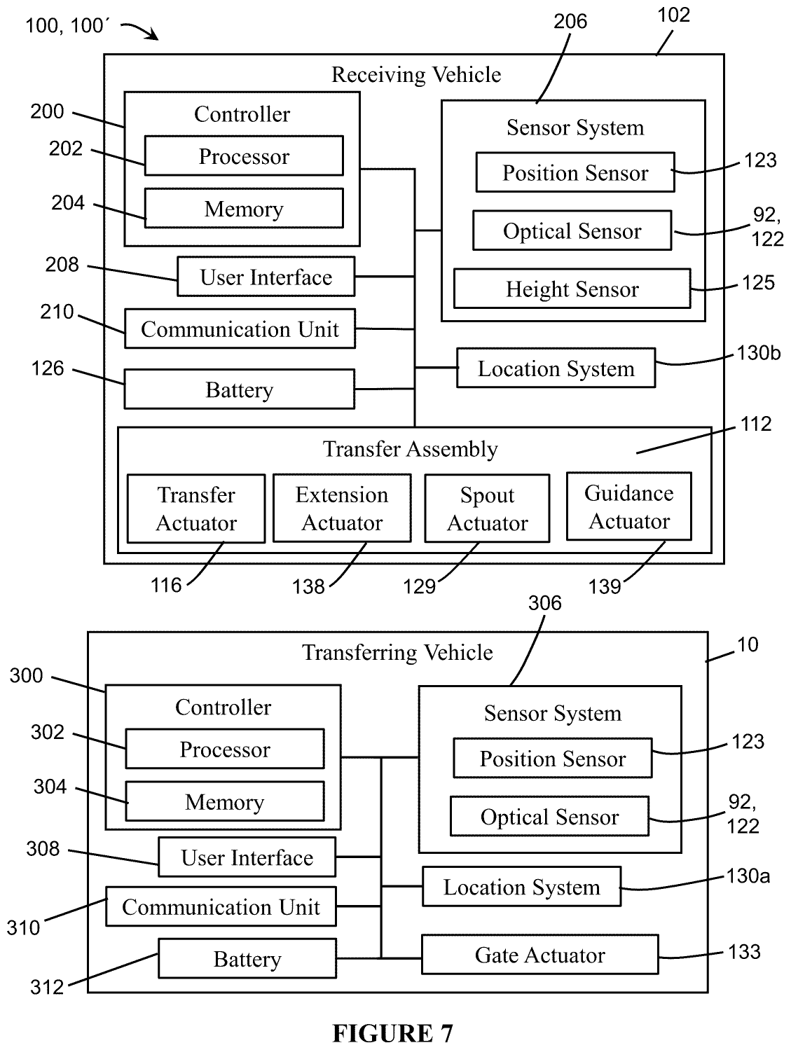

The alignment between the transferring vehicle 10 and the receiving vehicle 102, including whether the transferring vehicle 10 and the receiving vehicle 102 are properly aligned for a transfer of agricultural material 108 to the receiving vehicle 102, can be determined in a variety of manners. For example, according to certain embodiments, either or both the receiving vehicle 102 and the transferring vehicle 10 can include one or more sensors 92, including, but not limited to, optical sensors, electromagnetic sensors, ultrasonic sensors, or physical contact sensors, as well as various combinations thereof, among other types of sensors. Moreover, the sensor 92 can be one or more of a proximity sensor, optical sensor, or position sensor, as well as any combinations thereof, among other sensors For example, according to certain embodiments, the sensor 92 is an optical sensor, such as, for example, a two-dimensional or three-dimensional cameras, among others, that can provide an image of at least a portion of the transferring vehicle 10, including, but not limited to, a fiducial marker 94 positioned on the transferring vehicle 10. Information obtained by use of the optical sensor 92 can be analyzed to determine a position of the receiving vehicle 102 relative to the transferring vehicle 10, as well whether the relative positions of the receiving vehicle 102 and the transferring vehicle 10 are appropriate. Including, for example, within a predetermined threshold distance or vicinity of each other, for the transfer of agricultural material 108 to the receiving vehicle 102. Additionally, or alternatively, location information, such as, for example, information provided by a location system(s) 130a, 130b (FIG. 7) of the transferring vehicle 10 and the receiving vehicle 102, including, but not limited to, global positioning satellite system (GPS), can be utilized determine the relative positions of the receiving vehicle 102 and the transferring vehicle 10, including whether such relative positions are appropriate to commence, as well as continue, a transfer of agricultural material 108 from the transferring vehicle 10 to the receiving vehicle 102.

FIG. 2 further illustrates a simplified example of a manner of transferring the agricultural material 108 from the transferring vehicle 10 to the receiving vehicle 102 using a transfer assembly 112a of the receiving vehicle 102. The transfer assembly 112a can be configured to transfer agricultural material 108 from the transferring vehicle 10 to the receiving vehicle 102 in a variety of different manners, including, but not limited to, via use of one or more conveyors, among other manners of transferring the agricultural material 108. According to certain embodiments, the transfer body 114a can include one or more tubed or hollowed bodies, segments, or hoses, or partially enclosed or gated segments, as well as any combinations thereof, that can accommodate transfer of agricultural material 108 between first and second ends 115a, 115b of the transfer body 114a. Moreover, the transfer body 114a is configured to at least partially, if not entirely, confine the agricultural material 108 during at least a portion of the transfer to the receiving vehicle 102 in a manner that prevents inadvertent spillage of other loss of the agricultural material 108 from the transfer body 114a. Further, the transfer body 114a can be constructed from a variety of materials, including metallic and non-metallic materials, as well as combinations thereof, including, but not limited to, elastomeric or rubber materials. Thus, according to certain embodiments, the transfer body 114a, or various portions thereof, can be ridged, flexible, or semi-flexible.

The transfer assembly 112a, or a portion thereof, may or may not be relatively static relative to the hauler 106. For example, according to certain embodiments, the transfer body 114a can be coupled to the hauler 106 in a manner that prevents independent movement of at least a portion, if not the entirety, of the transfer body 114a relative to at least the adjacent wall 107 or storage area 109 of the hauler 106. With such embodiments, the transfer body 114a can remain in an extended state. Thus, with such embodiments, the transfer body 114a can be positioned for a transfer of agricultural material 108 to the receiving vehicle 10 upon the receiving vehicle 102 attaining proper alignment with the transferring vehicle 10. What can constitute a proper alignment between the receiving vehicle 102 and the transferring vehicle 10 can be dependent on the orientation of the transfer body 114a, including the direction(s) the transfer body 114a extends away from the hauler 106. Alternatively, as discussed below, according to other embodiments, the transfer body 114a, or portion thereof, can be selectively displaced about one or more axes, or in one or more directions, including in connection with the transfer body 114a being in either a retracted state or the extended state. Further, as also discussed below, the transfer assembly 112a can be configured for guided movement of at least a portion of the transfer body 114a in connection with positioning the transfer assembly 112a for receipt of agricultural material 108 from the transferring vehicle 10.

FIG. 2 illustrates an example of a transfer body 114a that is generally static relative to the hauler 106, and thus can remain in the extended state. According to such an embodiment, the transfer body 114a can have a set orientation about a plurality of axes such that the transfer body 114a is, when the receiving vehicle 102 is properly aligned with the transferring vehicle 10 positioned to receive agricultural material 108 outputted by the transferring vehicle 10, and transport the received agricultural material 108 to a location at which the transported agricultural material 108 can be released into the storage area 109 of the hauler 106. For example, in the illustrated example, the transfer body 114a shown in FIG. 2 can generally remain in an extended state at which opposing first and second ends 115a, 115b of the transfer body 114a are, at least relative to each other or the hauler 106, generally at preset positions or orientations.

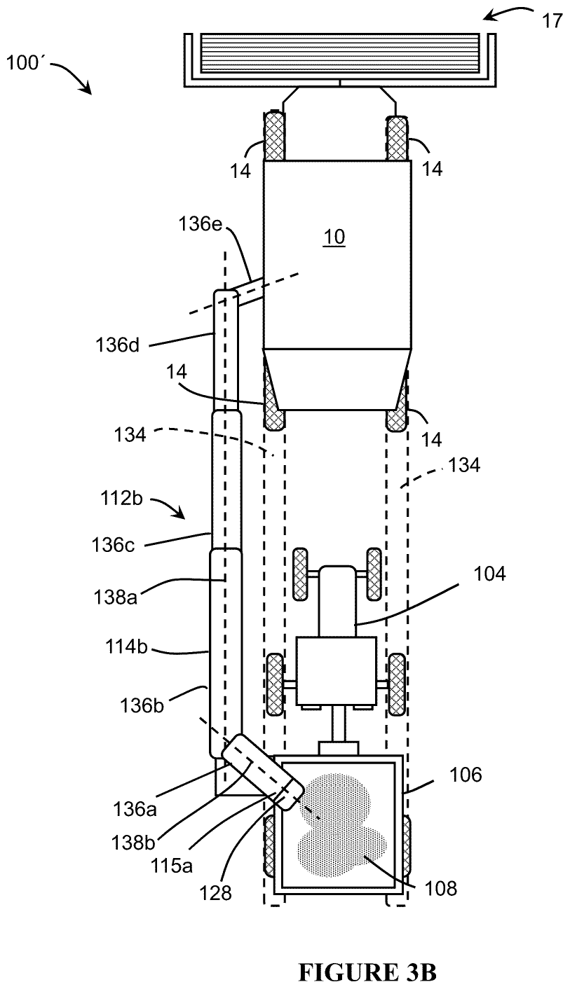

At least at the extended state of the transfer assembly 112a, the first and second ends 115a, 115b of the transfer body 114a, can have similar or dissimilar fore and aft, or longitudinal, positions (as generally indicated by the “x” direction shown in FIG. 2) and may, or may not, be laterally offset (as generally indicated by the “y” direction shown in FIG. 2) to each other or the hauler 106. For example, in the example shown in FIG. 2, the first end 115a and the second end 115b of the transfer body 114a are not aligned with each other in both the longitudinal and lateral directions. Additionally, the first 115a of the transfer body 114a can be at a vertical height or elevation that is different than a corresponding vertical height or elevation of an adjacent wall 107 of the hauler 106. Further, the vertical height or elevation of the first end 115a may, or may not, be different than a corresponding height or elevation of the second end 115b. For example, according to certain embodiments, at the extended state, the second end 115b of the transfer body 114a can be positioned beneath at least a portion of the transferring vehicle 10, such as, for example, at a vertical location that is lower than at least the grain tank 30 (FIG. 1) or other similar on-board storage vessel of the transferring vehicle 10. According to such an embodiment, the transferring vehicle 10 can include a discharge port 150 that can be vertically positioned below at least the grain tank 30 or other storage vessel such that agricultural material 108 can be delivered from the grain tank 30 or other storage vessel to, and through, the discharge port 150 via use of gravitational forces. For example, as illustrated by at least FIGS. 4A and 4B, the discharge port 150 can, according to certain embodiments, be positioned along, or extend from, a bottom wall or base 11a of the transferring vehicle 10. However, according to other embodiments, the discharge port 150 can extend from a generally vertical wall of the transferring vehicle 10 at a location that is vertically lower than the grain tank 30 or other storage vessel, thereby still utilizing at least gravitational forces in the discharge of agricultural material 108 through the discharge port 150.

Flow of agricultural material 108 through the discharge port 150 can be controlled in a variety of manners, including, for example, one or more valves or gates 131 (FIG. 4A). The gate 131 can, according to certain embodiments, be opened or closed, or otherwise turned on or off, via activation of a gate actuator 133 (FIG. 7), including, for example, an electric motor. Thus, selective activation of the gate actuator 133 can be utilized to open or close the flow of agricultural material 108 though at least the discharge port 150. According to certain embodiments, such operation of the gate actuator 133, and the associated opening and closing of the gate 131, can be in response to a command provided by an operator of the transfer management system 100. Alternatively, or additionally, one or more sensors, including, but not limited to, proximity, optical, or position sensors, as well as any combinations thereof, among other sensors, can provide information regarding the position of the transfer assembly 112 relative to the discharge port 150 that can be used to automatically trigger activation of the gate actuator 133, and the associated opening or closing of the gate 131. Alternatively, according to other embodiments, the gate 131 can be a poppet valve that can be opened by an engagement between the discharge port 150 and a portion of the transfer assembly 112a.

Such use of gravity to displace and release agricultural material 108 from the transferring vehicle 10 to the transfer assembly 112a can eliminate the auger 31 or other conveyance means of the transferring vehicle 10, as well as the associated structures. The absence such a conveyance means of the transferring vehicle 10 can provide savings in terms of at least a reduction in power consumption for the transferring vehicle 10, including, for example, eliminating the use of electrical power from one or more power sources, including batteries 312 (FIG. 7) of the transferring vehicle 10 to operate such conveyance means. Additionally, or alternatively, such a configuration can also eliminate the inclusion, or size, of the grain tank 30. For example, rather than delivering clean grain to a grain tank 30, the transferring vehicle 10 can be configured for the clean crop routing assembly 28, or other portion of the transferring vehicle 10, to direct the agricultural material 108 to the discharge port 150, and not to a grain tank 30 or other similar on-board storage vessel. Such a configuration can further result in a reduction in the size and weight of the transferring vehicle 10, which can facilitate a reduction in the associated cost of the transferring vehicle 10, the power consumed for the operation of the transferring vehicle 10, and soil compaction by the transferring vehicle 10. However, the transfer assemblies of the receiving vehicles 102 discussed herein can also be used with transferring vehicles that include an unloading conveyor 32, or other conveyance means, similar to that discussed above with respect to the transferring vehicle 10 shown in FIG. 1. Additionally, regardless of whether the transferring vehicle 10 does, or does not, include a conveyance means used in the dispensing of the agricultural material 108 to the discharge port 150, according to certain embodiments, the discharge port 150 can include a conveyance means, including, but not limited to, a belt, slate, auger, or pneumatic conveyor, that can be used to displace agricultural material 108 to a location that may provide improved access for receipt by the transfer assemblies discussed herein.

The transfer body 114a can be configured such that, when the transfer assembly 112a is at the extended state, and with proper alignment between the transferring vehicle 10 and the receiving vehicle 102, the transfer assembly 112a receives the agricultural material 108 released from the discharge port 150 of the transferring vehicle 10. For example, the second end 115b of the transfer body 114a can include a catch basin 120 that is configured to receive the agricultural material 108 released through the discharge port 150 of the transferring vehicle 10. The catch basin 120 can have a variety of shapes and configurations, and may or may not be configured for coupling to the discharge port 150. For example, according to certain embodiments, the catch basin 120 can be a basket shaped receptacle that can be positioned either or both around and beneath the discharge port 150. Alternatively, or additionally, the catch basin 120 can be coupled to the discharge port 150, such as, for example, via a selectively releasable mating engagement or coupling. Additionally, according to certain embodiments, the coupling of the catch basin 120 to the discharge port 150 can trigger an opening of the gate 131 or other portion of the transferring vehicle 10 such that agricultural material 108 can flow through the discharge port 150 and into the catch basin 120.

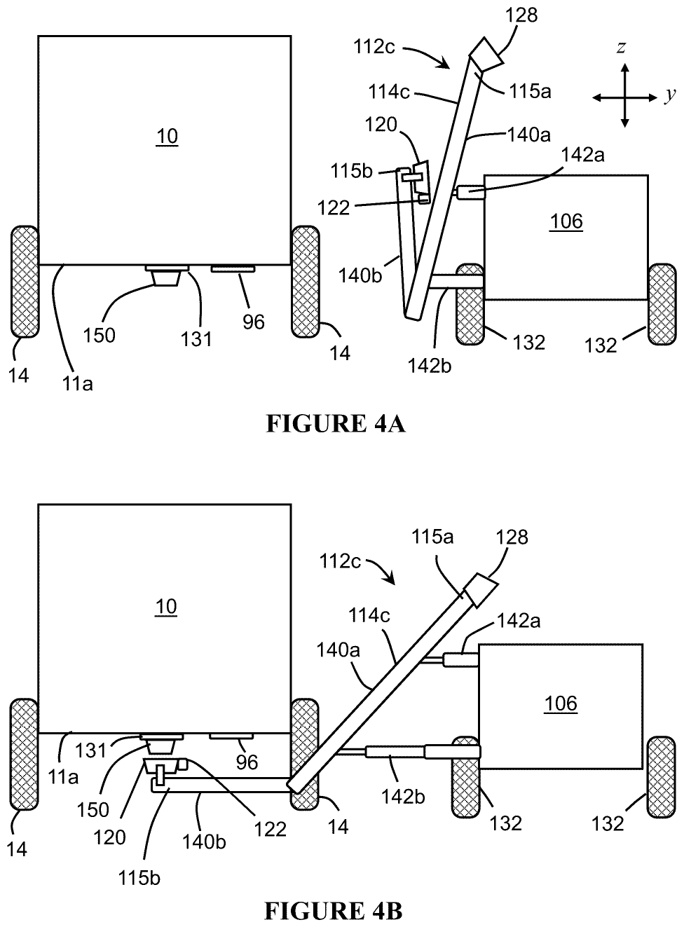

As seen in at least FIG. 4B, according to certain embodiments, the transfer assembly 112a or other portion of the receiving vehicle 102, or transferring vehicle 10, can include one or more optical sensors 122, position sensors 123 (FIG. 7), or height sensors 125 (FIG. 7), among other sensors, that are configured to provide information used to determine, including identify, whether the transfer assembly 112a is at an appropriate position to receive agricultural material 108 dispensed through the discharge port 150 of the transferring vehicle 10. A variety of different types of sensors, including, but not limited to, optical sensors and position sensors, among others, can be utilized to determine whether transfer assembly 112a, including, for example, the catch basin 120, is positioned, including, for example, within a predetermined distance, among other predetermined thresholds, to receive the agricultural material 108 dispensed through the discharge port 150. For example, according to certain embodiments, the sensor 122 is an optical sensor that can capture information containing an image of one or more fiducial markers 96 that can provide information to either or both an operator of the receiving vehicle 102 or an associated controller(s) 200, 300 (FIG. 7) that can indicate a relative position of the catch basin 120, and, moreover, can provide information as to whether the release of the agricultural material 108 from the transferring vehicle 10 and into the transfer assembly 112a can commence. Additionally, as seen by a comparison of at least FIGS. 4B and 5, according to certain embodiments, the location of the fiducial marker 96 used for determining the position of the transfer assembly 112a, including, for example, the catch basin 120, relative to at least the discharge port 150 can be at least partially based on the location of the discharge port 150.

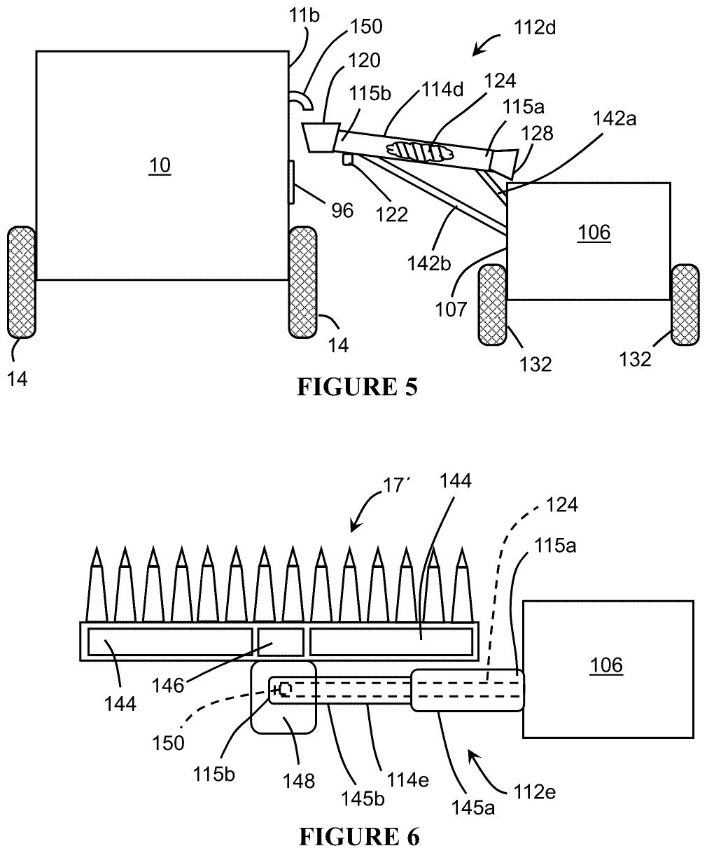

The transfer system 112a can further include one or more conveyors 124 that are positioned along, and may be housed within, at least a portion of the transfer body 114a. A variety of different types of conveyors can be utilized as the conveyor(s) 124, including, but not limited to, a belt conveyor, slate conveyor, roller conveyor, auger screw conveyor (FIG. 5), or pneumatic conveyor (FIG. 6), as well as combinations thereof, among other conveyors. Selective operation of the conveyor(s) 124 can include activation of an associated transfer actuator(s) 116 (FIG. 7), such as, for example, electric motor, pump, or vacuum, among other actuators, of the transfer assembly 112a. According to such embodiments, power for the transfer actuator(s) 116 can be supplied by one or more power sources of the receiving vehicle 102, including, for example, one or more batteries 126 (FIG. 7), among other types of power sources, as discussed above. Further, the one or more conveyors 124 can be configured to transport the received agricultural material 108 generally from at or around the first end 115a to a location generally at or around the second end 115b of the transfer body 114a. Additionally, according to certain embodiments, the conveyor(s) and can also be configured to impart a force to dispense the agricultural material 108 out of the transfer assembly 112a and into the storage area 109 of the hauler 106.

According to certain embodiments, the first end 115a of the transfer body 114a can be coupled to a spout 128 of the transfer assembly 112a that is configured to be selectively displaceable relative to at least the storage area 109. For example, the spout 128 can be configured to be either or both rotatably displaceable about one or more axes and linearly displaceable in a manner that can influence where agricultural material 108 is deposited or distributed by the transfer assembly 114a into the storage area 109. As discussed below, a controller 200, 300 can be configured to generate one or more signals to facilitate activation of a spout actuator 129 in a manner that can selectively displace the spout 128 in a generally horizontal plane, about a generally vertical axis, adjust a tilt angle of the spout 128 in a relatively vertical plane, or adjust a flap or discharge angle associated with the discharge of the agricultural material 108 into the storage area 109, as well as any combination thereof. According to such an embodiment, the rotation angle, tilt angle and flap angle can be associated with different axes (e.g., mutually orthogonal axes).

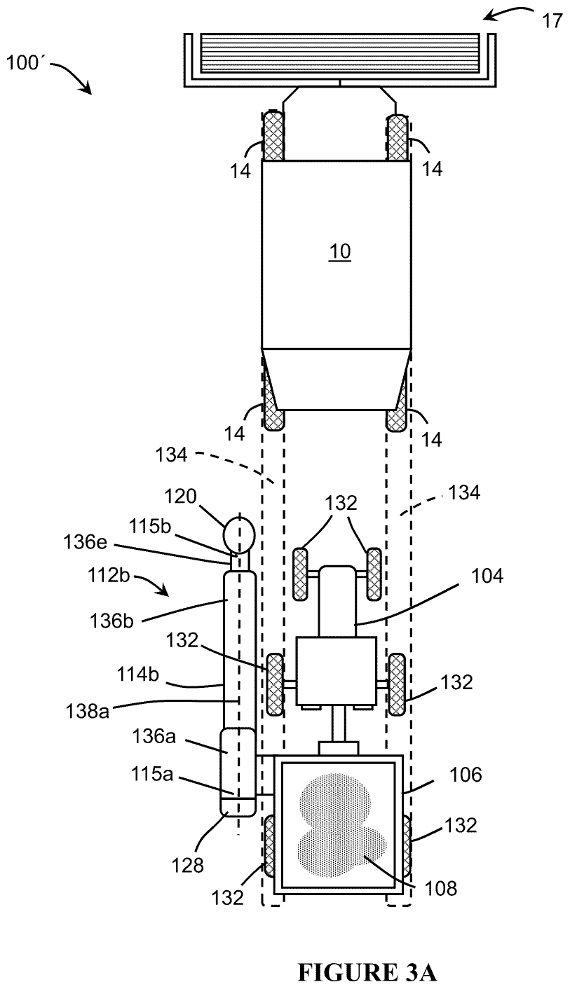

As demonstrated by at least FIG. 3B, according to certain embodiments, the transfer body 114a, 114b can be configured such that, when the transfer assembly 112a, 112b is at the extended state, at least some of the ground engagement bodies 132 of the receiving vehicle 10, including for example, wheels or tracks, or combinations thereof, can be position to travel along the same tram lines 134 that are, have been, or will be traveled by the wheels 14 of the transferring vehicle 10. Such configurations can be utilized to minimize the area of the field that experiences soil compaction relating to the travel of the wheels 14 and ground engagement bodies 132 along ground surface of the field. Thus, for example, with respect to the embodiment of the transfer assembly 112b shown in FIG. 3B, and further discussed below, at least the transfer assembly 112b can be configured such that the receiving vehicle 102 travels either laterally in front or behind the transferring vehicle 10 such that the wheels 14 and ground engagement bodies 132 are currently at least partially traveling along at least some of the same tram lines 134. FIG. 2 however illustrates another embodiment in which the transfer assembly 112a is configured to, in at least the lateral direction, be offset from the transferring vehicle 10 such that the transferring vehicle 10 and the receiving vehicle 102 are in an at least partial side-by-side arrangement wherein one of the transferring vehicle 10 and the receiving vehicle 102 may, or may not, also be in a more laterally forward direction than the other of the transferring vehicle 10 and the receiving vehicle 102. According to such an embodiment, the transfer assembly 112a can be configured such that, as agricultural material 108 is being transferred from the transferring vehicle 10 to the receiving vehicle 102, the ground engagement bodies 132 of the receiving vehicle 102 can travel along tram lines 134 that are different than the tram lines 132 that the transferring vehicle 10 is currently traveling along.

FIGS. 3A and 3B illustrate another exemplary embodiment of a transfer management system 100′ in which the transfer assembly 112b of the receiving vehicle 102 can be selectively displaced between a retracted state, as shown in FIG. 3A, and an extended state, as shown in FIG. 3B. According to the illustrated transfer management system 100′, the transfer body 114b of the transfer assembly 112b includes a plurality of transfer body segments 136a, 136b, 136c, 136d, 136e (collectively referred to herein as transfer body segments 136a-e), at least some of the transfer body segments 136a-e being displaceable relative to one or more other transfer body segments 136a-e. According to such an embodiment, one or more extension actuators 138 (FIG. 7), such as, for example, electric motors, hydraulic cylinders, or pneumatic cylinders, as well as combinations thereof, among other actuators, as well as associated couplings, linkages, or gearing, can be selectively operated in a manner that can facilitate displacement of one or more of the transfer body segments 136a-e in one or more directions. Additionally, each body segment 136a-f may include a conveyor 124, or, alternatively, a portion of the conveyor 124 of the transfer assembly 112b. Such configurations can thus accommodate one or more continuous conveyors 124 that can extend across a plurality of transfer body segments 136a-f, separate conveyors 124 that can interlock or otherwise engage with conveyors in one or transfer body segments 136a-f, or separate conveyors 124 for one or more, if not all, of the transfer body segments 136a-f, as well as any combinations thereof.

As seen by a comparison of FIGS. 3A and 3B, according to certain embodiments, the illustrated transfer body 114b can include a first transfer body segment 136a that extends from the first end 115a of the transfer body 112b to a second transfer body segment 136b. According to the illustrated embodiment, the first transfer body segment 136a can be at least rotatably displaceable relative to the second transfer body 136b. For example, the first transfer body segment 136a can be rotatably displaced from being generally aligned with at least the second transfer body segment 136b along a common first axis 138a, as seen in FIG. 3A, to being generally aligned with a second axis 138b that may be either or both non-parallel and non-perpendicular to the first axis 138a, as seen in FIG. 3B. Additionally, or alternatively, such displacement of the first transfer body segment 136a can involve the first transfer body segment 136a being displaced in other, or additional, directions, including, for example with respect to a direction that may adjust, for example, either or both an elevation or tilt of the first transfer body segment 136a, and a lateral position of at least the first end 115a of the transfer body 112b.

While the first axis 138a can extend in a variety of directions, according to the illustrated embodiment the first axis 138a can generally extend in at least a longitudinal direction that is generally parallel to an adjacent wall 107 of the hauler 106. Further, while FIGS. 3A and 3B illustrate the first axis 138a as being generally parallel to the direction of travel 110, which can also be referred to as the longitudinal direction, of the receiving vehicle 102, the first axis 138a can be oriented in a variety of other directions, including, for example, extend in a lateral direction that is so as to be angularly offset of the direction of travel 110 or the longitudinal direction, as well as be tilted, sloped, or inclined in at least the vertical direction.

As also demonstrated by the exemplary transfer body 112b shown in FIGS. 3A and 3B, at least some transfer body segments 136b, 136c, 136d, 136e can be telescopically arranged. According to such an example, as the transfer assembly 114b is displaced between the extended state and the retracted state, one or more of the extension actuators 138 can be selectively operated to facilitate a lateral displacement of one or more of the transfer body segments 136b, 136c, 136d, 136e generally along the first axis 138a, among displacement in one or more other or additional directions. Such a telescopic configuration can be utilized to, when the transfer assembly 112b is at the retracted state, reduce a size or footprint of, or otherwise compact, the transfer assembly 112b. Further, to the extent the first axis 138a is not arranged to also accommodate an adjustment to an elevation or inclination of the telescopically arranged transfer body segments 136b, 136c, 136d, 136e, one or more of the of the transfer body segments 136b, 136c, 136d, 136e can also be displaced to adjust either or both a vertical height and angular orientation of at least a portion of the transfer body 114b. Such adjustments in the vertical height or tilt of the transfer body segments 136b, 136c, 136d, 136e can be configured to assist in directing the second end 115b or catch basin 120 to a location to receive agricultural material 108 released from the transferring vehicle 10 through the discharge port 150. For example, as seen in FIG. 3B, in addition to accommodating linear displacement of the telescopically arranged end transfer body segment 136e that extends to the second end 115B of the transfer body 114b, the end transfer body segment 136e can also be rotatably displaced to extend along a third axis 138c that may be either or both on-parallel and non-perpendicular to the first axis 138a. According to such an embodiment, such adjustment in either or both position and orientation of the end body segment 136e can facilitate the second end 115b of the transfer body 114b, including, the associated catch basin 120, being positioned beneath at least a portion of the transferring vehicle 10, as similarly demonstrated with respect to the embodiment shown in at least FIG. 4B. As discussed below, the transfer system 112b can further include one or more guidance actuators 139 (FIG. 7) that can further assist in manual or automatic guided movement of at least a portion of the transfer body 114b.

FIGS. 4A and 4B illustrate another exemplary embodiment of at least a portion of a transfer assembly 112c of the receiving vehicle 102 in a retracted state and an extended state, respectively. As illustrated, the transfer body 114c can included a plurality of transfer body segments 140a, 140b that are, at least with respect to each other, displaceable from a folded position that corresponds to the transfer assembly 112c being at the retracted state, and an unfolded position that corresponds to the transfer assembly 112c being at the extended state. Such a foldable configuration of the transfer body 114c can be configured to reduce, or compact, the size of the transfer assembly 112c at least when the transfer assembly 112c is in the retracted state.

FIGS. 4A and 4B further illustrate at least one of the transfer body segments 140a, 140b of the transfer body 112c being coupled to the hauler 106 by one or more attachment bodies 142a, 142b, such as, for example, one or more linkages or cylinders, including, for example, hydraulic or pneumatic cylinders. According to such embodiments, one or more of the extension actuators 138 can be selectively activated in a manner that can extend, or retract, the attachment bodies 142a, 142b in a manner that can displace the transfer body segments 140a, 140b to either fold, or unfold the transfer body 112c. Additionally, one or more other extension actuators 138 can be further utilized to adjust an orientation of one or more of the transfer body segments 140a, 140b, including either or both together or individually, to assist in positioning the second end 115b of the transfer body 112c or the catch basin 120 at a position to receive agricultural material 150 release from the discharge port 150 of the transferring vehicle 10. The illustrated transfer assembly 112c can further include one or more conveyors 124 similar to those discussed above with respect to at least FIGS. 3A and 3B.

FIG. 5 illustrates another exemplary embodiment of a portion of a transfer assembly 112d of a receiving vehicle 10 in an extended state. According to the illustrated embodiment, the transfer assembly 112d can include a conveyor 124 in the form of auger conveyor that is housed within the transfer body 114d of the transfer assembly 112d. Unlike prior examples, the transferring vehicle 10 illustrated in FIG. 5 includes a discharge port 150 that is positioned about a generally vertical side wall 11b of the transferring vehicle 10. According to such an embodiment, the discharge port 150 may, or may not, be at a vertical position at which gravity can be utilized in the transfer of agricultural material 108 within the transferring vehicle 10 to, and out from, the discharge port 150. Thus, according to certain embodiments, the transfer of the agricultural material 108 within the transferring vehicle to the discharge port 150 can include a conveyance means similar to that discussed above with respect to FIG. 1. However, positioning the discharge port 150 on a vertical side wall 11b, as opposed to along the bottom wall or base 11a, can provide certain benefits, including, for example, with respect to minimizing concerns relating to potential ground clearance issues.

Additionally, the transfer assembly 112d shown in FIG. 5 may, or may not, be configured for retraction from the extended state to a retracted state. For example, according to certain embodiments, similar to the transfer assembly 112a discussed above with respect to FIG. 2, the attachment bodies 142a, 142b can be configured to remain at a relatively static positions relative to at least the adjacent wall 107 of the hauler 106. Alternatively, similar to the embodiments discussed above with respect to at least FIGS. 3A-4B, the attachment bodies 142a, 142b, among other portions of the transfer body 114d, can be coupled to one or more extension actuators 138, and, optionally, one or more guidance actuators 139, in a manner that can be utilized in selectively displacing the transfer assembly 112d between extended and retracted states, and guided movement of at least a portion of the transfer body 114d, as previously discussed.

FIG. 6 illustrates another simplified representation of an exemplary embodiment of a portion of a transfer assembly 112e of a receiving vehicle 106 in the extended state. In the illustrated example, the transfer assembly 112e can include, as the conveyor 124, one or more pneumatic conveyors. According to such an embodiment, the pneumatic conveyor(s) can be operated to provide a negative pressure across at least a portion of the transfer body 114e that can provide a vacuum or suction force for transferring agricultural material 108 from the transferring vehicle 10 to the receiving vehicle 102, and, moreover, to the storage area 109 of hauler 106. Additionally, in the illustrated embodiment, the discharge port 150 of the transferring vehicle 10 can be positioned along, or around, a portion of the header 17′. Moreover, according to exemplary illustrated embodiment, harvested agricultural material 108 can be transferred via one or outer belt conveyors or side belts 144 and to a central belt conveyor 146, including, but not limited to, a central draper belt. According to such an embodiment, at, or downstream of, the central conveyor belt 146, the header 17′, or other part of the transferring vehicle 10, can include a housing 148 at which the discharge port 150 can be positioned. Agricultural material 108 received within the housing 148 can be drawn out of the housing 148 via at least a suction force provided by the pneumatic conveyor of the transfer assembly 112e. Additionally, as previously discussed, the transfer assembly 112e can be configured to remain in the extended state, as shown in FIG. 6, or to accommodate selective displacement of one or more transfer body segments 145a, 145b between an extended configuration for the extended state, as shown in FIG. 6, to a more compact retracted configuration associated with a retracted state of the transfer assembly 112e via selective operation of one or more extension actuators 138.

While FIG. 6 provides an example of a transfer assembly 112e coupled to the header 17′ having a conveyor 124 in the form of a pneumatic conveyor, a pneumatic conveyor, among other types of conveyors or combinations of conveyors, can be used with the other transfer assemblies 122a-d discussed herein. Thus, for example, rather than being coupled to the header 17′, a transfer assembly of the receiving vehicle 102 that has a pneumatic conveyor, as well as other types of conveyors 124, can also be used in connection with transferring agricultural material 108 that has been supplied to the discharge port 150 via use of gravity, be used with systems in which the grain tank is eliminated, and be used with systems in which the transferring vehicle 10 has a conveyance means similar to that discussed above with respect to FIG. 1.

FIG. 7 illustrates a block diagram of an exemplary transfer management system 100, 100′ configured for transferring an agricultural material 108 from a transferring vehicle 10 to a receiving vehicle 102 using a transfer assembly 112a-e (collectively generally referred to herein as transfer assembly 112) of the receiving vehicle 102. As seen, each of the receiving vehicle 102 and the transferring vehicle 10 can include one or more controllers 200, 300, each controller 200, 300 having at least one or more processors 202, 302 and one or more memory devices 204, 304, respectively. The processors 202, 302 can be configured to follow instructions, including control instructions contained with, or are part of, one or more of the memory devices 204, 304, including, for example, a non-transitory machine-readable medium.

The processors 202, 302 can be embodied as any type of processor or other compute circuit capable of performing various tasks such as, for example, using information from the one or more of the location systems 130a, 130b to determine relative positions of the receiving vehicle 102 and the transferring vehicle 10, as well as using information from one or more sensor systems 206, 306, or sensors, to at least determine whether the transfer assembly 112 is to be in the extended state or retracted state, or if the transfer assembly 112 is positioned to receive agricultural material 108 released through the discharge port 150 of the transferring vehicle 10. In some embodiments, each processor 202, 302 can be embodied as a single or multi-core processor, a microcontroller, or other processing or controlling circuit. Additionally, in some embodiments, each processor 202, 302 may be embodied as, include, or be coupled to an FPGA, an application specific integrated circuit (ASIC), reconfigurable hardware or hardware circuitry, or other specialized hardware to facilitate performance of the functions described herein. In some embodiments still, each processor 202, 302 can be embodied as a high-power processor, an accelerator co-processor, an FPGA, or a storage controller.

Each memory device 204, 304 can be embodied as any type of volatile (e.g., dynamic random-access memory (DRAM), etc.) or non-volatile memory capable of storing data therein. Volatile memory can be embodied as a storage medium that requires power to maintain the state of data stored by the medium. Non-limiting examples of volatile memory can include various types of random-access memory (RAM), such as dynamic random-access memory (DRAM) or static random-access memory (SRAM). In some embodiments, each memory device 204, 304 can be embodied as a block addressable memory, such as those based on NAND or NOR technologies. Each memory device 204, 304 can also include future generation nonvolatile devices or other byte addressable write-in-place nonvolatile memory devices. Additionally, in some embodiments, each memory device 204, 304 can be embodied, or otherwise include, a memory device that uses chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. Each memory device 204, 304 can refer to the device itself or to a packaged memory product. In some embodiments still, 3D crosspoint memory can include a transistor-less stackable cross point architecture in which memory cells sit at the intersection of word lines and bit lines and are individually addressable and in which bit storage is based on a change in bulk resistance. In some embodiments yet still, all or a portion of each memory device 204, 304 can be integrated into the processor(s) 202, 302. Regardless, each memory device 204, 304 can store various software and data used during operation such as task request data, kernel map data, telemetry data, applications, programs, libraries, and drivers. Thus, the memory devices 204, 304 can include information, including, but not limited to, algorithms and look-up tables, among other information, that can used by the processor 202, 302, including with respect to the operation of the transfer assembly 112.

The controllers 200, 300 can be electrically coupled to one or more user interfaces 208, 308 of the receiving vehicle 102 and the transferring vehicle 10, respectively. The user interfaces 208, 308 can, according to certain embodiments, include an input device, an output device, or combination thereof. A variety of different types of devices can be utilized as the user interfaces 208, 308, including, for example, a touch screen, keyboard, keypad, mouse, switch, joystick, or button, as well as any combinations thereof, among other types of user interfaces. According to certain embodiments, the user interfaces 208, 308 can be positioned in an operator cab 16 of the transferring vehicle 10, and a similar cab of the receiving vehicle 102. Additionally, or alternatively, either or both of the user interfaces 208, 308 can be part of a mobile or handheld device or other device that can be remotely located from the corresponding receiving vehicle 10 and transferring vehicle 102. One or more of the user interfaces 208, 308 can be utilized to selectively activate operation of the transfer assembly 112, including operation of one or more of the transfer actuator 116, extension actuator 138, guidance actuator 139, and spout actuator 129. For example, according to certain embodiments the user interface 208, 308 can be utilized by an operator to generate one or more commands to initiate the controller 200, 300 to generate one or more signals to facilitate the activation of one or more extension actuators 138 to selectively control displacement of the transfer assembly 112 between the retracted state and the extended state. Additionally, according to certain embodiments, the user interface 208, 308 can be utilized by an operator to generate one or more commands to initiate the controller 200, 300 to generate one or more signals to facilitate the activation of one or more transfer actuators 116 that provide power for, or used to drive, operation of one or more conveyors 124 of the transfer assembly 112.

According to certain embodiments, the transfer assembly 112 can include one or more guidance actuators 139 that can accommodate guided movement of at least a portion of the transfer assembly 112, including the transfer body 114a-e, or portion thereof. For example, according to certain embodiments, one or more, if not all, of the transfer body segments 136a-e, 140a-b, 145a, 145b can be displaced in one or more directions via operation of one or more guidance actuators 139, including, but not limited to, electric motors, to assist in aligning the transfer assembly 112 with the discharge port 150 of the transferring vehicle 10. Such activation and guided movement of at least a portion of the transfer body 114a-e can be automatically controlled, including, for example, via the controller 200, 300 utilizing information provided by the sensor system 206, 306, such as, for example, information captured by either or both one or more optical sensors 92, 122 and position sensors 123. Additionally, or alternatively, such guided movement of at least a portion of the transfer body 114a-e can be controlled by user operation of the user interface 208, 308, including, but not limited to, user operation of an associated joystick, among other types of user interfaces 208, 308.

Either or both of the sensor systems 206, 306 can include one or more position sensors 123 that can measure, sense, or detect information regarding a longitudinal, latitudinal, vertical, or angular position(s), as well as any combinations thereof, of one or more components of at least the transfer assembly 112, including, for example, the transfer body 114a-e, transfer body segments 136a-e, 140a-b, 145a, 145b, or the spout 128, as well as any combination thereof. Thus, for example, the position sensor 123 can include an angular position sensor that can provide information regarding an angular position of one or more portions of the transfer body 114a-e about one or more axes of rotation, and, moreover can provide information indicative of an angular orientation of the transfer body 114a-e in one or more directions relative to the hauler 106 or the ground surface. Thus, for example, the position sensor 123 can be an angular position sensor that can provide information regarding the extent one or more portions of the transfer body 114a-e extend away from the hauler 106 in at least one or both of the latitudinal and longitudinal direction(s), and additionally, or optionally, in the vertical direction, as well as various combinations thereof. Such information can at least assist in detection of when the transfer body 114a-e is at the extended or retracted state, as well as positions therebetween, or otherwise is, or is not, positioned to receive agricultural material 108 released through the discharge port 150 of the transferring vehicle 10. Further, the position sensor 123 can include one or more angular position sensors that can provide information regarding an angular orientation of the spout 128 about one or more axis, which can assist in the unloading of agricultural material 108 from the transfer assembly 112 and into the storage area 109. While FIG. 7 illustrates particular sensors in connection with the illustrated sensor systems 206, 306, the sensor systems 206, 306 can include a variety of other sensors in addition to, or in lieu of, those shown in FIG. 7 and discussed herein.

Either or both the receiving vehicle 102 and the transferring vehicle 10 can also include a communication unit 210, 310 that can be configured to support or provide communications between at least the controller 200 of the receiving vehicle 102 and the controller 300 of the transferring vehicle 10. The communication units 210, 310 can include wireless communication system components (e.g., via cellular, Wi-Fi, Bluetooth or the like), and can also include one or more wired communications terminals, such as universal serial bus ports, among others. According to certain embodiments, the units 210, 310 can be communicatively coupled to each other via a network, including, for example, via internet, cellular, or Wi-Fi networks, as well as various combinations thereof. Such connection to the network can facilitate an exchange of information, including information between the controllers 200, 300 of the receiving vehicle 102 and the transferring vehicle 10.

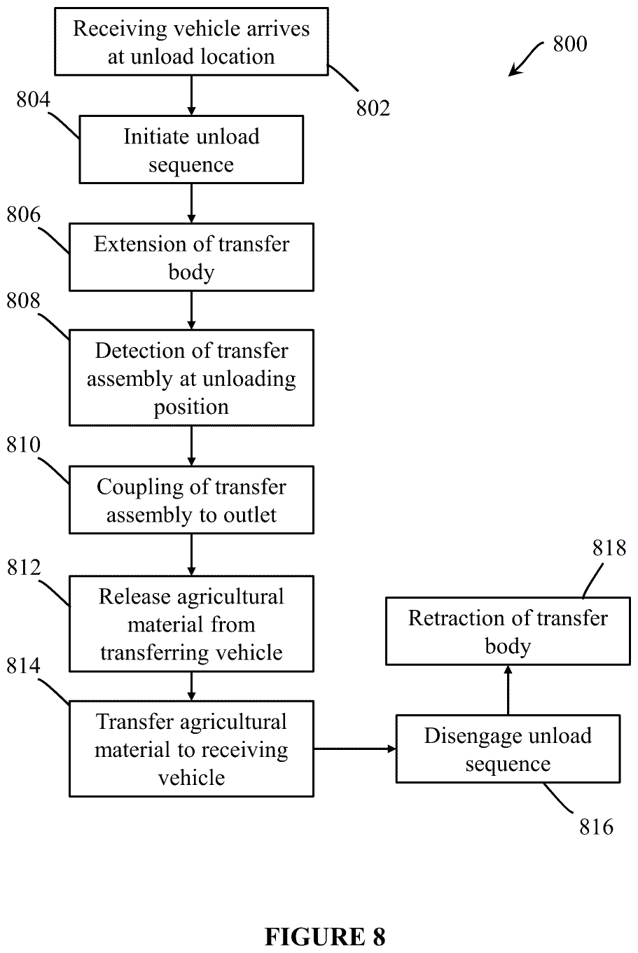

FIG. 8 illustrates a simplified flow diagram of an exemplary method 800 for transferring agricultural material 108 from the transferring vehicle 10 to the receiving vehicle 102. The method 800 is described below in the context of being carried out by the illustrated exemplary transfer management system 100, 100′ shown in at least FIG. 7. However, it should be appreciated that method 800 can likewise be carried out by any of the other described implementations, as well as variations thereof. Further, the method 800 corresponds to, or is otherwise associated with, performance of the blocks described below in the illustrative sequence of FIG. 8. It should be appreciated, however, that the method 800 can be performed in one or more sequences different from the illustrative sequence. Additionally, one or more of the blocks mentioned below may not be performed, and the method 800 can include steps or processes other than those discussed below.

At block 802, the receiving vehicle 102 can be determined, such as, for example, by the controller 200, 300 to have arrived at an unload location. According to certain embodiments, the unload location can correspond to the receiving vehicle 102 being in proper alignment with the transferring vehicle 10 such, when the transfer assembly 112 is, if not already, at the extended state, agricultural material 108 dispensed or outputted from the discharge port 150 can be received by the transfer assembly 112 of the receiving vehicle 102. As previously discussed, determination of the receiving vehicle 102 being in proper alignment with the transferring vehicle 10 can be determined in a variety of manners. For example, according to certain embodiments, determining that the receiving vehicle 102 is in proper alignment with the transferring vehicle 10 can be based on information provided by the location systems 130a, 130b of the transferring vehicle 10 and the receiving vehicle 102, including, for example, based on a evaluation of the GPS positions of the receiving vehicle 102 and the transferring vehicle 10. Additionally, or alternatively, determination of the receiving vehicle 102 being in the unload location can be based on information provided by one or more optical sensors 92, 122, including, but not limited to, information that can be utilized to detect either or both the relative positions and orientations of the receiving vehicle 102 and the transferring vehicle 10.

At block 804, with the receiving vehicle 102 properly aligned with the transferring vehicle 10, to the extent not automatically initiated by the controller 200, 300, the user interface 208, 308 can be engaged by the operator to send a command to the controller 200, 300 to facilitate initiation of an unload sequence. According to certain embodiments, such an initiation of the unload sequence can include the controller 200, 300 generating one or more signals to facilitate operation of one or more of the extension actuators 138 such that the transfer assembly 112 is displaced from the retracted state to the extended state, as indicated by block 806. Additionally, or alternatively, initiation of the unload sequence can facilitate operation of one or more of the transfer actuators 116 utilized to power the one or more conveyors 124 of the transfer assembly 112. Further, as previously discussed, with respect to at least certain embodiments, initiation of the unload sequence can include one or more guidance actuators 139 being used to guide movement of at least a portion of the transfer assembly 112, including, for example, at least a portion of the transfer body 114a-e to location at which the transfer assembly 112, including, for example, the catch basin 120, is positioned to receive agricultural material 108 that will be discharged through the discharge port 150 of the transferring vehicle 10.

At block 808, a determination can be made as to whether the transfer assembly 112, including, for example, the transfer body 114a-e or catch basin 120, is positioned to receive agricultural material 108 that will be discharged through the discharge port 150 of the transferring vehicle 10. For example, according to certain embodiments, information provided by the sensor system 206, 306, including, but not limited to, information provided by one or more of the position sensor 123, optical sensor 122, or height sensor 125, among other sensors, can be used by the controller 200, 300 to verify that the transfer assembly 112, or portion thereof, is positioned to receive the agricultural material 108 that is to be released from the transferring vehicle 10. Alternatively, or additionally, such confirmation of the transfer assembly 112 or portion thereof, being appropriately positioned to receive the agricultural material 108 from the transferring vehicle 10 can be performed by the operator, including, for example, via use of information presented or displayed on the user interface 208, 308.

Optionally, according to certain embodiments in which the catch basin 120 may be coupled to the discharge port 150 during the transfer of the agricultural material, the method 800 can include, at block 810, a determination by the controller 200, 300 or operator that such a coupling has been attained. For example, with respect to the transfer assembly 112e illustrated FIG. 6 that utilizes a pneumatic conveyor 124, in an effort to aid the transfer of the agricultural material 108 via use of a suction force, the catch basin 120 can be configured for a mating engagement with the discharge port 150, including, but not limited to, a removable press fit engagement. Further, according to certain embodiments in which the catch basin 120 becomes coupled to the discharge port 150, the valve or gate 131 can be a poppet style valve that opens in response to the coupling of the catch basin 120 to the discharge port 150, and closes in response to the catch basin 120 be decoupled from the discharge port 150.

At block 812, with the transferring assembly 112 of the receiving vehicle 102 at least properly positioned relative to the discharge port 150 of the transferring vehicle 10, the agricultural material 108 can be released from the transferring vehicle 10. Again, according to certain embodiments, such a release of the agricultural material 108 can include the controller 200, 300 generating one or more signals to open a corresponding gate 131 of the transferring vehicle 10 such that agricultural material 108 can flow through the discharge port 150 and into the transferring assembly 112 of the receiving vehicle 102. The agricultural material 108 being released from the transferring vehicle 10 through the discharge port 150 can then be transferred via at least operation of one or more conveyors 124 of the transfer assembly 112 to the storage area 109 of the hauler 106 at block 814. Such transfer of the agricultural material 108 can further include the controller 200, 300 selectively generating one or more signals to facilitate the operation of one or more spout actuators 129 to control at least an orientation of the spout 128 in a manner that can control the distribution of the agricultural material 108 within the storage area 109 of the hauler 106, as previously discussed.

Upon completion of the transfer of the agricultural material 108 to the storage area 109 of the hauler 106, one or more signals can be generated trigger the controller 200, 300 to facilitate a deactivation of the unload sequence at block 816. The deactivation of the unload sequence can be triggered in a variety of different manners, including, manually by an operator of the transfer management system 100, 100′ providing one or more commands to the controller 200, 300 via use of the user interface 208, 308. Additionally, or alternatively, deactivation of the unload sequence can be triggered by satisfaction of a predetermined amount, weight, or quantity of transferred agricultural material 108, satisfaction of a storage capacity of the storage area 109 or hauler 106, or in response to a depletion or absence of agricultural material 108 within the transferring vehicle 10, among other possible triggers. According to certain embodiments, such deactivation of the unload sequence can further include decoupling of the catch basin 120 from the discharge port 150, deactivation of one or more transfer actuators 116, or activation of one or more guidance actuators 139 to guide at least a portion of the transfer assembly 112 away from the discharge port 150 or the transferring vehicle 10. Additionally, with the transfer assembly 112 deactivated, at block 818, one or more extension actuators 138 can be activated to displace the transfer assembly 112 from the extended state to the retracted state.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A receiving vehicle for hauling an agricultural material transferred to the receiving vehicle from a transferring vehicle as the transferring vehicle is harvesting the agricultural material, the receiving vehicle comprising:
a plurality of ground engagement bodies;
at least one power source;
a storage area configured to store the agricultural material; and
a transfer assembly comprising a transfer body, a transfer actuator, and a conveyor,
the conveyor being housed within at least a portion of the transfer body and being driven by an operation of the transfer actuator, the transfer actuator being powered by the at least one power source, and
the transfer body including a first end and a second end, the second end configured to receive agricultural material as the agricultural material is released from the transferring vehicle, the conveyor configured to transfer the agricultural material received at the second end to the first end, the first end being positioned for a release of the agricultural material into the storage area.

2. The receiving vehicle of claim 1, wherein the transfer assembly is selectively displaceable between a retracted state and an extended state, wherein the extended state, and not the retracted state, is configured for the second end of the transfer body to be positioned to receive the agricultural material released from the transferring vehicle.

3. The receiving vehicle of claim 2, wherein a footprint of the transfer body is smaller for the retracted state than for the extended state.

4. The receiving vehicle of claim 3, wherein the transfer body includes a plurality of transfer body segments, at least some of the plurality of transfer body segments being telescopically arranged.

5. The receiving vehicle of claim 4, wherein the transfer assembly further comprises a guidance actuator powered by the at least one power source, the guidance actuator configured to facilitate guided displacement of at least one transfer body segment of the plurality of transfer body segments.

6. The receiving vehicle of claim 3, wherein the retracted state is a folded state of at least a portion of the transfer body, and wherein the extended state is an unfolded state of the portion of the transfer body.

7. The receiving vehicle of claim 2, wherein the extended state is configured for the second end to be at a vertical position between a portion of the transferring vehicle and an adjacent ground surface.

8. The receiving vehicle of claim 1, wherein the conveyor comprises a negative pressure generated by the transfer actuator.

9. A receiving vehicle for hauling an agricultural material transferred to the receiving vehicle, the receiving vehicle comprising:
a ground engagement body;
a power source;
a storage area configured to store the agricultural material; and
a transfer assembly comprising a transfer body, a transfer actuator, and a conveyor, at least a portion of the transfer assembly being selectively displaceable between a retracted state and an extended state via an operation of an extension actuator, the extension actuator being powered by the power source,
the conveyor housed within at least a portion of the transfer body and driven by an operation of the transfer actuator to displace agricultural material from a second end to a first end of the transfer body, the transfer actuator being powered by the power source,
the second end of the transfer body being displaceable from a first position to a second position with a displacement of the portion of the transfer assembly from the retracted state to the extended state, the second position being further from the storage area than the first position, and
the first end of the transfer body being positioned, with the transfer assembly at the extended state, for a release of the agricultural material from the transfer assembly into the storage area.

10. The receiving vehicle of claim 9, wherein a footprint of the transfer body is smaller for the retracted state than for the extended state.

11. The receiving vehicle of claim 9, wherein the transfer body includes a plurality of transfer body segments, at least some of the plurality of transfer body segments being telescopically arranged.

12. The receiving vehicle of claim 9, wherein the retracted state is a folded state of the portion of the transfer body, and wherein the extended state is an unfolded state of the portion of the transfer body.

13. The receiving vehicle of claim 9, wherein the transfer body includes a plurality of transfer body segments, and wherein the transfer assembly further comprises a guidance actuator powered by the power source, the guidance actuator configured to facilitate guided displacement of at least one transfer body segment of the plurality of transfer body segments.

14. The receiving vehicle of claim 9, wherein the conveyor comprises a negative pressure generated by the transfer actuator.

15. A method for transferring an agricultural material from a transferring vehicle to a receiving vehicle using a transfer assembly of the receiving vehicle, the method comprising:
generating, by one or more processors, a signal to facilitate an operation of a extension actuator of the receiving vehicle to displace at least a portion of the transfer assembly from a retracted state to an extended state, wherein a second end of a transfer body of the transfer assembly is displaced, by displacement of the portion of the transfer assembly to the extended state, to a position to receive the agricultural material from the transferring vehicle;
generating, by the one or more processors, as the receiving vehicle and the transferring vehicle travel along a field as the transferring vehicle is performing a harvesting operation and the portion of the transfer assembly is in the extended state, a signal to facilitate a displacement of a gate of the transferring vehicle from a close position to an open position, the open position configured to accommodate a release of the agricultural material from the transferring vehicle to the second end of the transfer body; and
generating, by the one or more processors, a signal to activate a transfer actuator to operate a conveyor of the transfer assembly to displace the agricultural material being received from the transferring vehicle at the second end of the transfer body to a first end of the transfer body, the first end positioned to accommodate a release of the agricultural material from the transfer assembly and into a storage area of the receiving vehicle.

16. The method of claim 15, further comprising determining, by the one or more processors, and as the receiving vehicle and transferring vehicle travel along the field, a position of the receiving vehicle relative to the transferring vehicle, and wherein generating the signal to facilitate the operation of the extension actuator is in response to the position of the receiving vehicle relative to the transferring vehicle being determined to satisfy a first predetermined threshold.

17. The method of claim 16, further comprising sensing, by one or more sensors, a position of the second end of the transfer body relative to a discharge port of the transferring vehicle, and wherein generating the signal to facilitate the displacement of the gate to the open position is in response to the position of the second end of the transfer body relative to the discharge port being determined to satisfy a second predetermined threshold.

18. The method of claim 15, wherein generating the signal to activate the transfer actuator comprises supplying a power from a power source of the receiving vehicle to operate the transfer actuator.

19. The method of claim 15 further comprising generating a signal, by the one or more processors, to displace the portion of the transfer assembly from the extended state to the retracted state in response to a detection of a trigger event as the receiving vehicle travels along the field.

20. The method of claim 19, wherein the trigger event is a signal received from a user interface of either the transferring vehicle or the receiving vehicle.
